(19) United States
(12) Patent Application Publication
(10) Pub. No.: US 2008/0169310 A1
(43) Pub. Date: Jul. 17, 2008

(54) Liquid dispensing device

(76) Inventor: Roman T. Mata, San Diego, CA (US)

Correspondence Address: JAMES RAY & ASSOCIATES, 2640 PITCAIRN ROAD, MONROEVILLE, PA, 15146, US

(21) Appl. No.: 12/002,163

(22) Filed: Dec. 14, 2007

Related U.S. Application Data
(60) Provisional application No. 60/871,146, filed on Dec. 21, 2006.

(51) Int. Cl. B67D 5/06; B67D 5/60; B67D 3/00

(52) U.S. Cl. 222/185.1; 222/143; 222/481

(57) ABSTRACT

A liquid dispensing device includes a base with a well disposed one of within and on a center portion of such base for receiving and securing a bottle. The well including a sealing mechanism. A vent mechanism has a first portion disposed one of within and on such base and a second portion extends into a bottle from a neck of such bottle. A third portion is connected at a first end thereof to such second portion adjacent the neck and at a second end thereof to the first portion. The third portion is further connected to a valve mechanism communicating a flow of air into the valve mechanism and interrupting such flow of air in a second position. A fluid dispensing mechanism has a first dispensing portion in fluid communication with the well and a second dispensing portion in a position for dispensing liquid into a predetermined container.

### CROSS REFERENCE TO RELATED APPLICATION

This patent application is related to and claims priority from U.S. Provisional Patent Application Ser. No. 60/871,146 filed Dec. 21, 2006.

### FIELD OF THE INVENTION

The present invention relates, in general, to liquid dispensers and, more particularly, this invention relates to dispensers for liquids contained in two and three liter bottles.

### BACKGROUND OF THE INVENTION

Prior to the conception and development of the present invention, liquid dispensers, as are generally well known in the prior art, have been used to distribute fluids.

Specifically of interest to the present invention are the following: Briggs, U.S. Pat. No. 6,109,482, discloses a soda dispensing assembly including a base having a recess formed therein for receiving a neck of an inverted soda bottle to receive fluid therefrom. A spigot is coupled to a bottom of the recess and a bottom end extending therefrom so as to exit the base and terminate in an open end, and a valve mechanism selectively allows fluid to flow from the open end of the spigot.

Salvail, U.S. Pat. No. 4,715,516, discloses an apparatus for dispensing carbonated beverages and the like from a container. A body portion is adapted to replace a screw top cap of the container. The body portion includes a tube which will project into the ullage volume of the container and will vent to the atmosphere via a normally closed vent valve. A normally closed fluid valve is disposed in the body portion between a fluid chamber and a spout. In use the container having the body portion attached thereto is essentially inverted and supported in a stand. A dispensing lever attached to the body is depressed and sequentially opens the vent valve and the fluid valve permitting the beverage to flow through the fluid chamber, the fluid valve and the spout by gravity.

Stewart, et al, U.S. Pat. No. 4,386,718, discloses a dispenser of liquid from an inverted rigid screw neck container, the dispenser including a base with an upwardly directed socket to receive the container neck in a liquid tight manner, a port to discharge liquid to a threaded nose to be coupled to a tap, an air bleed arrangement to deliver atmospheric air through a stem and a one way valve into a container when mounted on the base.

Reynard, U.S. Pat. No. 3,042,267, discloses a dispensing device for a liquid including a support provided with an opening and a pair of passages disposed alongside one another and having open outer ends at one side of the device. A container for a liquid has an opening communicating with the opening in the support and one of the passages through which the liquid may be released. Means for connecting the other passage with the interior of the container for venting air through the passage, means mounted on the support, and a pair of resilient valve means connected to the mounted means at a location exteriorly of the passages for opening and closing the outer ends for respectively controlling the flow of liquid and air through such passages.

Lukasik, U.S. Pat. No. 6,540,111, discloses a bottled soda dispenser for dispensing soda from a 2-liter bottle without having to remove the cap each time. The invention allows for one hand dispensing and keeps the carbonation in the bottle. The dispenser consists of the base, a bottle holder, a valve system and actuating levers. An air inlet having a check valve provides sufficient air in the bottle as the soda is withdrawn.

### SUMMARY OF THE INVENTION

The present invention provides a liquid dispensing device. Such liquid dispensing device includes a base. A well is disposed one of within and on a center portion of such base for receiving and securing a mouth of a bottle with such liquid dispensing device. The well includes a sealing means disposed therein for preventing liquid from leaking from such bottle once such bottle is inverted for dispensing of liquid from within such bottle.

A vent means has a first portion disposed one of within and on such base, a second portion extending into an interior portion of such bottle from a neck of such bottle to a point closely adjacent a bottom of such bottle, and a third portion connected at a first end thereof to the second portion closely adjacent such neck and at a second end thereof to the first portion at a predetermined location thereon. The third portion is further connected at a predetermined location to a valve means communicating a flow of air into the valve means and interrupting such flow of air in a second position.

A fluid dispensing means has a first portion in fluid communication with the well and a second dispensing portion in a position for dispensing liquid into a predetermined container.

### OBJECTS OF THE INVENTION

It is, therefore, one of the primary objects of the present invention to provide a liquid dispensing device to enable a user to dispense liquids from a two or three liter bottle without spilling.

Another object of the present invention is to provide a liquid dispenser that will enable children to easily serve themselves.

Still another object of the present invention is to provide a liquid dispensing device that will eliminate the need for a user to lift a two or three liter bottle in order to obtain quantities of the liquid within such bottle.

Yet another object of the present invention is to provide a liquid dispensing device that has a base that can be combined with a series of bases to form a single large liquid dispensing area for the convenience of the user.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to a first embodiment of the invention.

FIG. 2 is a partial perspective view of the invention according to a first embodiment of the invention.

FIG. 3 is a partial perspective view of a part of the invention according to a first embodiment of the invention.

FIG. 4 is a partial perspective view of a part of the invention according to a first embodiment of the invention.

FIG. 5 is a partial perspective view of the invention according to a first embodiment of the invention.

FIG. 6 is a partial perspective view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

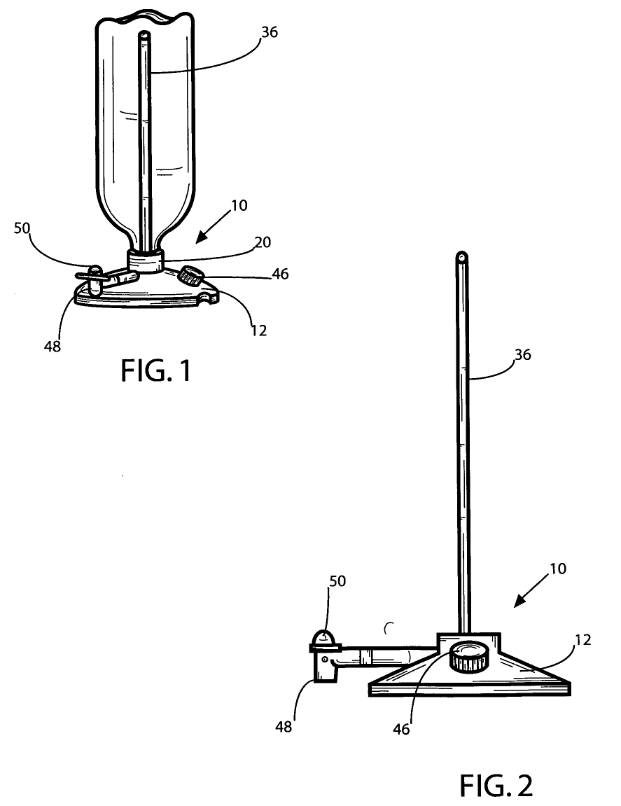

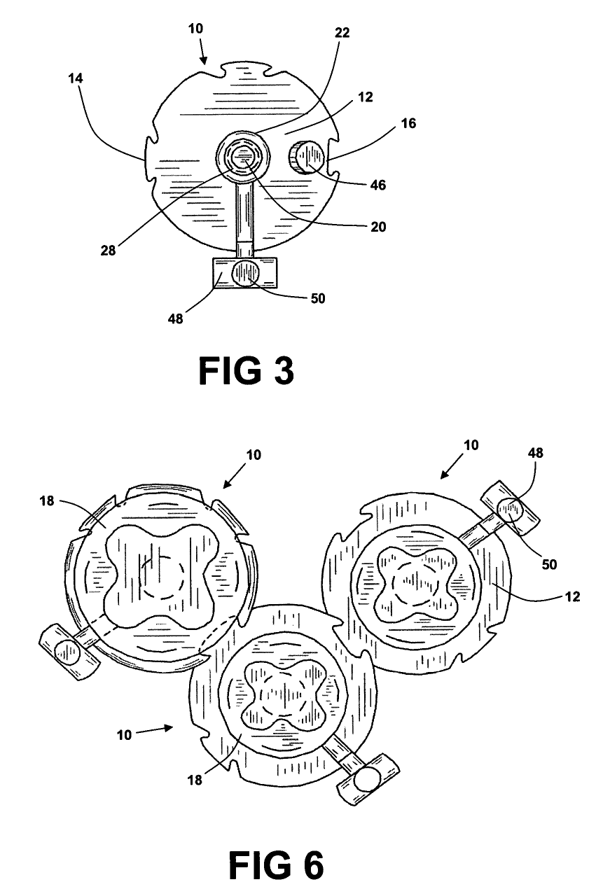

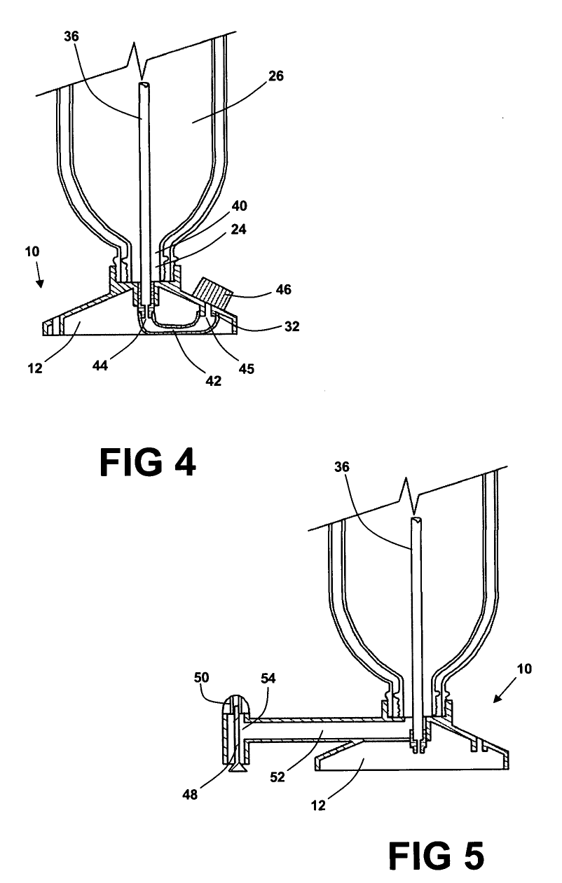

Reference is now made, more particularly, to FIGS. 1-6.

A liquid dispensing device, generally designated 10, is provided. Such liquid dispensing device 10 includes a base 12. In the presently preferred embodiment the base 12 is manufactured from polystyrene. It is further presently preferred that the base 12 is between about 5½ inches wide and 6½ inches wide. It is most preferred that such base 12 is about 6 inches wide.

It is also presently preferred that the base 12 has at least one male cutout 14 and at least one female cutout 16 such that it can be joined to at least one other base 18. In the presently preferred embodiment, the base 12 is produced in a variety of colors.

A well 20 is disposed one of within and on a center portion 22 of such base 12 for receiving and securing a mouth 24 of a bottle 26 with the liquid dispensing device 10. In the presently preferred embodiment, such well 20 is disposed on the center portion 22 of such base 12.

The well 20 includes a sealing means 28 disposed therein for preventing liquid (not shown) from leaking from such bottle 26 once such bottle 26 is inverted for dispensing of liquid from within such bottle 26.

In the presently preferred embodiment the well 20 is threaded and the sealing means 28 is an o-ring type seal.

A vent means 32 has a first portion 34 disposed one of within and on the base 12, a second portion 36 extending into an interior portion of such bottle 26 from a neck 40 of such bottle 26 to a point closely adjacent a bottom of such bottle 26, and a third portion 42 connected at a first end 44 thereof to the second portion 36 closely adjacent the neck 40 of such bottle 26 and at a second end 45 thereof to the first portion 34 at a predetermined location thereon.

The third portion 42 is further connected at a predetermined location to a valve means 46 communicating a flow of air into the valve means 46 and interrupting such flow of air in a second position.

It is further presently preferred that the first portion 34, the second portion 36, and the third portion 42 have a predetermined configuration. It is presently preferred that such predetermined configuration is at least one of cylindrical, hexagonal, and octagonal. It is presently most preferred that such predetermined configuration is cylindrical.

A fluid dispensing means 48 has a first dispensing portion 52 in fluid communication with the well 20 and a second dispensing portion 54 in a position for dispensing liquid into a predetermined container (not shown). It is presently preferred that fluid dispensing means 48 is a push button spigot system 50.

It is presently preferred that the liquid dispensing device 10 is produced in a variety of colors.

According to a second embodiment of the invention, the sealing means is an elastomer disposed on an inner wall of the well 20 for sealing and engaging a threaded portion of such bottle.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. A liquid dispensing device comprising:
a. a base;
b. a well disposed one of within and on a center portion of said base for receiving and securing a mouth of a bottle with said liquid dispensing device, said well including a sealing means disposed therein for preventing liquid from leaking from such bottle once such bottle is inverted for dispensing of liquid from within such bottle;
c. a vent means having a first portion disposed one of within and on said base, a second portion extending into an interior portion of such bottle from a neck of such bottle to a point closely adjacent a bottom of such bottle, and a third portion connected at a first end thereof to said second portion closely adjacent such neck of such bottle and at a second end thereof to said first portion at a predetermined location thereon, said third portion being further connected at a predetermined location to a valve means communicating a flow of air into said valve means and interrupting such flow of air in a second position; and
e. a fluid dispensing means having a first dispensing portion in fluid communication with said well and a second dispensing portion in a position for dispensing liquid into a predetermined container.

2. A liquid dispensing device according to claim 1 wherein said fluid dispensing means is a push button spigot system.

3. A liquid dispensing device according to claim 1, wherein said base is manufactured from polystyrene.

4. A liquid dispensing device according to claim 1 wherein said base is between about 5% inches wide and 6% inches wide.

5. A liquid dispensing device according to claim 1 wherein said base has at least one male cutout and at least one female cutout such that it can be joined to at least one other base.

6. A liquid dispensing device according to claim 1 wherein said base is produced in a variety of colors.

7. A liquid dispensing device according to claim 1 wherein said liquid dispensing device is produced in a variety of colors.

8. A liquid dispensing device according to claim 1 wherein said first portion, said second portion, and said third portion have a predetermined configuration.

9. A liquid dispensing device according to claim 8 wherein said predetermined configuration is at least one of cylindrical, hexagonal, and octagonal.

10. A liquid dispensing device according to claim 9 wherein said predetermined configuration is cylindrical.

11. A liquid dispensing device according to claim 1 wherein said sealing means is an elastomer disposed on an inner wall of said well for sealing and engaging a threaded portion of a bottle.

12. A liquid dispensing device according to claim 1 wherein said well is threaded and said sealing means is an o-ring type seal.

13. A liquid dispensing device according to claim 4 wherein said base is about 6 inches wide.

14. A liquid dispensing device according to claim 1 wherein said well is disposed on said center portion of said base.
